(19) United States
(12) Patent Application Publication
(10) Pub. No.: US 2023/0295393 A1
(43) Pub. Date: Sep. 21, 2023

(54) MICROPOROUS POLYMER FIBERS AND THEIR USE IN ENVIRONMENTAL REMEDIATION

(71) Applicant: UT-Battelle, LLC, Oak Ridge, TN (US)

(72) Inventors: Amit K. Naskar, Knoxville, TN (US); Ngoc A. Nguyen, Oak Ridge, TN (US)

(21) Appl. No.: 18/121,338

(22) Filed: Mar. 14, 2023

Related U.S. Application Data
(60) Provisional application No. 63/319,876, filed on Mar. 15, 2022.

(51) Int. Cl. C08J 9/26; C08L 67/03; C08L 33/20; C08L 77/02; C08L 97/00; C08J 9/35; C08L 23/12

(52) U.S. Cl. CPC C08J 9/26; C08L 67/03; C08L 33/20; C08L 77/02; C08L 97/005; C08J 9/35; C08L 23/12; C08J 2201/042; C08J 2205/044; C08J 2323/12; C08J 2367/03; C08J 2333/20; C08J 2377/02

(57) ABSTRACT

A porous composition comprising a porous organic polymer (POP) fiber having a diameter of at least 100 nm and a length of at least 1 mm and pores having a size within a range of 10 nm to 5 microns distributed over the surface and volume of the POP fiber, wherein the organic polymer is insoluble in water and may be selected from, e.g., polyolefins, polyesters, polyamides, and polyacrylonitrile. Also described herein is a method for producing a POP fiber comprising: (i) forming a precursor fiber from a blend of an organic polymer and lignin, wherein the lignin is present in the form of domains within the precursor fiber; and (ii) washing the precursor fiber with a solvent that dissolves the lignin to result in the POP fiber. Also described herein is a method for removing oil from an oil-water mixture comprising contacting the oil-water mixture with the POP fibers.

### CROSS REFERENCE TO RELATED APPLICATIONS

The present application claims benefit of U.S. Provisional Application No. 63/319,876, filed on Mar. 15, 2022, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to porous polymer fiber compositions and methods of making and using them, and more particularly, such compositions containing nanopores or micropores and wherein the polymer is a polyolefin, polyester, polyamide, or polyacrylonitrile.

### BACKGROUND

Porous polymer fibers that may be useful in environmental remediation (e.g., removal of oil from water) have been of interest for some time, but with only limited success. Foaming has been attempted, but the resulting pores are generally larger than ideal, with the bulk of the pores typically being greater than 500 nm or 1 micron. There would be an advantage in a process that could produce porous polymer fibers having smaller pore sizes less than 1 micron or 500 nm.

There would be a further advantage in a process that could use recycled plastic for producing such fibers, particularly since approximately 150 million tons of solid plastics are discarded every year in the world. Recycling 1 ton of plastic can theoretically save a substantial amount of energy (˜130 million kJ). However, only 10% or less of overall plastic waste is reused and about 90% or more go to landfills (Garcia, J. M. & Robertson, M. L. The future of plastics recycling. Science 358, 870-872, 2017). Polypropylene (PP) is one of the most prevalent plastics produced globally, occupying approximately 21% of the total non-fiber plastic production and waste. Thus, the efficient recycling of plastics, such as PP, for use in environmental remediation would result in a two-pronged simultaneous effort in helping the environment.

### SUMMARY

In a first aspect, the present disclosure is directed to porous organic polymer (POP) fibers having a diameter of at least 100 nm and a length of at least 1 mm and pores having a size within a range of 10 nm to 5 microns distributed over the surface and volume of the porous polymer fiber. For purposes of the invention, the POP fibers are insoluble in water since a primary use of the fibers is to absorb (remove) oil from water. In some embodiments, the POP fiber has a diameter of at least 1, 2, 5, or 10 microns. In further or separate embodiments, at least 50%, 60%, 70%, 80%, or 90% of the pores have a size in a range of 50 nm to 2 microns (or 100 nm to 1 micron, or 100 nm to 500 nm) distributed over the surface of the POP fiber. In further or separate embodiments, the organic polymer is or includes a polyolefin (e.g., polypropylene and/or polyethylene), a polyester (e.g., PET), polyamide (e.g., nylon 12), or polyacrylonitrile (PAN). In further or separate embodiments, the porous polymer fibers are in the form of a woven or non-woven material.

In another aspect, the present disclosure is directed to methods for producing the POP fibers. The methods include at least the following steps: (i) forming a precursor fiber from a blend of an organic polymer and lignin, wherein the organic polymer and lignin are immiscible with each other and the organic polymer is insoluble in water; the precursor fiber has a diameter of at least 100 nm and a length of at least 1 mm; and the lignin is present in the form of domains within the organic polymer in the blend and resulting precursor fiber, wherein the domains have a size within a range of 10 nm to 5 microns; and (ii) washing the precursor fiber with a solvent that dissolves the lignin to result in the porous organic polymer fiber, wherein the porous organic polymer fiber has a diameter of at least 100 nm and a length of at least 1 mm and pores having a size within a range of 10 nm to 5 microns distributed over the surface and volume of the porous organic polymer fiber. The lignin may be included in the blend and resulting precursor fiber in an amount of, for example, 10, 20, 30, 40, 50, or 60 wt % by weight of the blend or precursor fiber. In some embodiments, the organic polymer is or includes a polyolefin (e.g., polypropylene and/or polyethylene), a polyester (e.g., PET and/or plasticized PET), polyamide (e.g., nylon 12), or polyacrylonitrile (PAN). In further or separate embodiments, the precursor fiber is formed in step (i) by melt spinning the blend of the organic polymer and lignin. In further or separate embodiments, the blend of the organic polymer and lignin is produced, before step (i), by a process in which the organic polymer and lignin are melt blended. In some embodiments, the organic polymer and lignin are mixed in a solvated state in a common solvent followed by solution spinning to form the organic polymer-lignin blend fiber prior to separation or removal of lignin via solvent dissolution to produce POP fiber.

The present disclosure is also directed to methods for producing a complex-shaped outer surface geometry of POP fiber (e.g., multi-lobal or gear-shaped fiber). By one method, a precursor of POP fiber as a non-fugitive component is processed with a fugitive (sacrificial) component using a multi-component fiber processing method to produce a multi-component polymer fiber. The multi-component fiber is produced from, for example, a melt or solution of the respective components. The method includes subjecting a multi-component polymer fiber having a lignin-polymer mixed component as a non-fugitive polymer to a fugitive removal step to produce a complex-shaped outer surface geometry of POP fiber polymer fiber.

In another aspect, the present disclosure is directed to methods of removing a hydrophobic solvent from a mixture of immiscible solvents, or more particularly, removing oil or a hydrophobic solvent from an oil-water mixture or solvent mixture by use of the above described POP fibers. In the method, the solvent mixture or oil-water mixture is contacted with the POP fibers to result in the oil getting selectively absorbed into pores of the POP fibers, thereby removing the solvent or oil from the water. In particular embodiments, the POP fibers are in the form of a woven or non-woven material, which permits easier retrieval of the porous polymer fibers from the water.

### BRIEF DESCRIPTION OF THE FIGURES

FIGS. 1A-1F. FIG. 1A shows scanning electron microscopy (SEM) images of a molded PP sample containing 40 wt. % Organosolv hardwood (HW) lignin, wherein the molded sample shows large phase separation of lignin spherical particles from 10 to 25 μm. The right SEM image in FIG. 1A is a magnified view of a section of the left SEM image in FIG. 1A (as indicated in FIG. 1A, left image). The inset in the right image of FIG. 1A is a further magnified view of the lignin particles. The inset confirms the spherical shape of the lignin particles in the molded sample. FIG. 1B shows SEM images of a melt-spun PP fiber sample containing 40 wt. % hardwood (HW) lignin with nanoscale lignin phase separation characterized by lignin domains having a size in the range of 200-650 nm. The right SEM image in FIG. 1B is a magnified view of a section of the left SEM image in FIG. 1B (as indicated in FIG. 1B, left image). The inset in the right image of FIG. 1B is a further magnified view of the lignin particles. The inset shows that the lignin particles in the melt-spun fibers have a cylindrical shape. The cylindrical shape was formed by the fiber spinning process. FIG. 1C shows the measured two-dimensional wide-angle X-ray scattering (2D-WAXS) data of the molded PP-lignin sample. FIG. 1D shows the measured 2D-WAXS data of the PP-lignin melt-spun fiber. FIGS. 1E and 1F show the corresponding WAXS scattering intensity scanned in different angles of 0°, 45°, and 90° as a function of 2-theta of the two samples, i.e., molded sheet and spun fiber, respectively.

FIGS. 2A-2E. FIG. 2A shows melt-spun PP-lignin fibers (top digital image) and lignin dissolution of the fibers in dimethylformamide (DMF) (bottom digital image). FIG. 2B (top image) is a digital image of PP fibers after removing lignin by solvent. FIG. 2B (bottom) is a graph showing lignin removal efficiency, 90.3±8.7%. FIG. 2C (top) is an SEM image of a cross-section of a porous PP fiber formed after removal of lignin. FIG. 2C (bottom) is a magnified view of an area indicated in the cross-section in FIG. 2C (top). FIG. 2D (top and bottom) are photos showing the ability of porous PP fibers to separate oil from water. FIG. 2D (top) shows used pump oil floating on top of water, whereas FIG. 2D (bottom) shows the oil removed instantly after the porous PP fibers uptake the oil. FIG. 2E is a graph showing the amount of uptake (g/g) of water (0.51±0.14) and oil (9.59±0.82) in the PP porous fibers.

FIGS. 3A-3D. Graphs showing non-equilibrium state formation in the polymer matrix. Graphs showing heat flow as a function of temperature in three heating cycles of: pristine PP (FIG. 3A); zoomed-in glass transition temperature of PP contributed by mobile amorphous segments (FIG. 3B); PP-lignin film (FIG. 3C); and PP-lignin fiber (FIG. 3D).

FIGS. 4A-4G. Scheme of an example showing use of recycled PP with lignin to generate porous PP fibers for oil removal. FIG. 4A shows recycled PP. FIG. 4B shows a blend of recycled PP with 40 wt. % lignin. FIG. 4C shows melt-spun recycled PP-lignin fibers. FIG. 4D shows removal of lignin from melt-spun recycled PP-lignin fibers. FIG. 4E shows porous PP fibers after removing lignin. FIG. 4F shows an oil/water mixture with oil floating at the top. FIG. 4G shows oil removed from the oil-water mixture after contact with the recycled porous PP fibers.

### DETAILED DESCRIPTION

In a first aspect, the present disclosure is directed to porous organic polymer (POP) fibers having a diameter of at least 100 nm and a length of at least 1 mm and pores having a size within a range of 10 nm to 5 microns distributed over the surface and volume of the POP fiber. The term “diameter” indicates that the POP fibers have an approximately, substantially, or precisely circular shape. In the case of POP fibers having a partially flattened shape, the term “diameter” may refer to the greater width dimension, or the term “diameter” may be an average of the two width dimensions which are perpendicular to the length dimension. Generally, the POP fibers have an aspect ratio of at least 100, 500, or 1000, wherein the term “aspect ratio” refers to the ratio of length to width of the fiber. In some embodiments, the POP fibers are solid through, except for the presence of pores. In other embodiments, the POP fibers are hollow, i.e., tubular. In some embodiments, the POP fibers have a complex-shaped outer surface geometry, and may be solid or hollow.

In different embodiments, the diameter of the POP fibers may be precisely or about, for example, 100 nm, 200 nm, 500 nm, 1 micron, 2, microns, 5 microns, 10 microns, 20 microns, 50 microns, 100 microns, 200 microns, or 500 microns, or the diameter is within a range bounded by any two of the foregoing values, e.g., 100 nm to 500 microns, 100 nm to 1 micron, 1-500 microns, 10-500 microns, 1-50 microns, or 10-100 microns. In different embodiments, the length of the POP fibers is precisely, about, at least, or greater than 1 mm, 10 mm, 50 mm, 100 mm, 200 mm, 500 mm, 1000 mm (1 m), 2 m, 5 m, or 10 m. In some embodiments, the fiber is referred to as “continuous.” A continuous fiber is typically produced in a continuous processing operation in which the produced fiber is held in a reel (or creel), with long lengths (e.g., tens or hundreds of meters, or kilometers) of the fiber coiled (i.e., wound) within the reels. The fiber may also be in the form of smaller segments than a continuous fiber. In some embodiments, the smaller segments are produced by chopping of a continuous fiber. The continuous fiber is typically chopped into pieces having a length of at least or greater than 0.1 cm (1 mm) and less than 1 meter (1000 mm) or 100 mm. In different embodiments, the smaller segment fibers have a length of, for example, 1, 2, 3, 4, 5, 10, 20, 30, 40, or 50 mm, or a length within a range bounded by any two of the foregoing values (e.g., 1-50 mm, 2-50 mm, or 3-50 mm).

A substantial majority (e.g., at least or above 80%, 85%, 90%, or 95%) or all of the pores in the fibers have a size within a range of 10 nm to 5 microns. The term “size,” as used herein, includes pores having at least one, two, or all three of its dimensions independently within a range of 10 nm to 5 microns. In one embodiment, a portion, a substantial majority or all of the pores have only one of their dimensions within a range of 10 nm to 5 microns while the remaining two dimensions are outside of this pore size range (e.g., below 10 nm or above 5 microns). In another embodiment, a portion, a substantial majority, or all of the pores have only two of their dimensions within a range of 10 nm to 5 microns while the remaining two dimensions are outside of this pore size range (e.g., below 10 nm or above 5 microns). In another embodiment, a portion, a substantial majority, or all of the pores have all three of their dimensions within a range of 10 nm to 5 microns. In other embodiments, a portion, a substantial majority, or all of the pores have at least one, two, or all three of their dimensions within a range of 50 nm to 2 microns, or within a range of 100 nm to 1 micron, or within a range of 100 nm to 800 nm, or within a range of 100 nm to 500 nm, or within a range of 200 nm to 800 nm, or within a range of 200 nm to 500 nm. In some embodiments, at least a portion or all of the pores are approximately, substantially, or precisely spherical in shape, in which case the pore size may be referred to as a pore diameter. In other embodiments, at least a portion or all of the pores have an oval, striated, cylindrical, or filamentous shape. In yet other embodiments, at least a portion or all of the pores have a fused globular, globular cluster (aggregated globular), or amorphous shape.

At least a portion (e.g., at least or greater than 70%, 80%, or 90%) or all of the pores present in the POP fiber have at least a portion of their surface areas open at the surface of the POP fiber in order for the POP fiber to be useful in absorbing solvents, such as oil or other hydrophobic contaminants, from a medium, particularly an aqueous medium. In some embodiments, a minor portion (e.g., no more than or less than 50%, 40%, 30%, 20%, or 10%) of the pores may be completely embedded within (i.e., distributed within the volume of) the fiber, which is not desired since this limits their ability to absorb oil or other hydrophobic contaminants. In other embodiments, a substantial portion or all of the pores have access to the surface and are not completely embedded within the volume of the fiber.

The organic polymer can be any of the organic polymers known in the art that can be processed into fibers and which are insoluble in water. For purposes of the invention, as further discussed below, the organic polymer should also be insoluble with lignin, yet melt-blendable with lignin. The organic polymer may be selected from, for example, polyolefins (e.g., polypropylene, polyethylene, polybutylene, or polybutadiene, or copolymer of any of these), polyesters (e.g., polyethylene terephthalate or poly(ethyl acrylate)), polyacrylonitrile (PAN) (typically a copolymer thereof), polycarbonates, polyurethanes, polyamides (e.g., Nylon 12, Nylon 6, or Nylon 6,6), polysulfone, polyimide, and polystyrene, provided the organic polymer is melt-processable. In some embodiments, at least a portion or all of the organic polymer is derived from plastic or polymer waste. In other embodiments, the organic polymer is original (virgin) polymer.

In some embodiments, the POP fibers are a component of an overall larger porous composition in which the POP fibers are integrated. For example, the POP fibers may be a component of a woven or non-woven material. The woven or non-woven material may be constructed exclusively of the POP fibers or constructed of the POP fibers in combination with other fibers that may or may not be porous. The POP fibers can be formed into a woven or non-woven material by means well known in the art. In the case of a non-woven mat, the POP fibers may be arranged into a non-woven mat or paper form, and then bonded, such as by hot stamping, partial melting, plasticization, melt-blown extrusion, or needle punching process, all of which are well known in the art.

In another aspect, the present disclosure is directed to methods for producing the POP fiber described above. In the method, a precursor fiber is first formed from a blend of an organic polymer and lignin, wherein the organic polymer and lignin are immiscible with each other, and the organic polymer is insoluble in water. The organic polymer may be any of the organic polymers described earlier above. The precursor fiber has any of the length and width dimensions described earlier above. Generally, the final POP fiber has the same length and width dimensions as the precursor fiber. The lignin is present in the form of domains within the organic polymer in the blend and resulting precursor fiber, wherein the domains have a size within a range of 10 nm to 5 microns, as described earlier above for the pores in the POP fiber. The lignin domains can have any of the sizes, size ranges, or size distributions described earlier above for the pores in the POP fibers. Any of the methods known in the art for producing fiber from a polymer melt or blend can be used to form the precursor fiber, except that the process should maintain the presence of lignin domains within the POP fiber. Some examples of suitable fiber producing processes include melt spinning, solution spinning, and electro spinning.

In a subsequent step, the precursor fiber is washed with a solvent (i.e., first solvent) that dissolves the lignin to result in the POP fiber, wherein the POP fiber has the length and width dimensions and porosity described earlier above, i.e., a diameter of at least 100 nm and a length of at least 1 mm, as described earlier above, and pores having a size within a range of 10 nm to 5 microns distributed over the surface and volume of the POP fiber, as described earlier above. The solvent used to remove the lignin is any solvent in which the lignin is substantially soluble, including solvents described in subsequent portions of this disclosure. The solvent should completely remove the lignin from the precursor fiber. Some examples of solvents useful for lignin removal include dimethylformamide (DMF), dimethyl sulfoxide (DMSO), acetonitrile, and alkaline water (e.g., water containing an alkali hydroxide, such as NaOH or KOH).

The washing step may also include stirring or otherwise agitating the precursor fiber in the solvent at an elevated temperature (i.e., above room temperature, e.g., precisely, about, or at least 30, 40, 50, 60, 70, 80, 90, or 100° C., or within a range bounded therein, and below the boiling point of the solvent used) for a suitable period of time, such as precisely, about, or at least 0.5, 1, 2, 3, 4, 5, 6, 12, 18, 24, 36, or 48 hours, to ensure complete removal of the lignin. In the case where the precursor fibers are stirred in the solvent, the stirring can be performed at a suitable rpm speed, such as 50, 100, 150, 200, 250, or 300 rpm at room temperature (e.g., about 25° C.) or at any of the temperatures provided above and for any of the times provided above. The solvent used to remove the lignin should also be removed, typically by drying or by washing the precursor fiber (as already washed with the first solvent) with a second solvent in which the first solvent is fully soluble, wherein the second solvent generally has a lower boiling point and is thus more volatile than the second solvent. After being washed with the second solvent, the precursor fiber is typically allowed to dry at room temperature or at a slightly elevated temperature (e.g., 30, 40, or 50° C.) for any of the periods of time provided above.

The blend used for forming the precursor fiber can be produced by any of the methods well known in the art for intimately mixing solid and semi-solid components. The components can be homogeneously blended by any of the methodologies known in the art for achieving homogeneous blends of solid, semi-solid, gel, paste, or liquid mixtures. Some examples of applicable blending processes include simple or high speed melt mixing, compounding, extrusion, two-roll milling, or ball mixing, all of which are well-known in the art. The process typically employs melting and blending of the components, which is known as a “melt blending” process. The process for preparing the polymer blend material can employ any suitable weight percentages (i.e., wt %) of polymer and lignin components. The lignin is typically included in an amount of 10-60 wt % by the total weight of the blend (or more typically, by the combined weight of the polymer and lignin in the blend). In different embodiments, the lignin is included in the blend in an amount (X) of precisely or about, for example, 10, 15, 20, 25, 30, 35, 40, 45, 50, 55, or 60 wt %, or an amount within a range bounded by any two of the foregoing values, e.g., 60 wt % polymer-40 wt % lignin, or 50 wt % polymer-50% wt % lignin, or 40 wt % polymer-60 wt % lignin. Typically, if the lignin is included in an amount X, the polymer is included in an amount of (100-X).

In particular embodiments, the blend is produced by a melt mixing process, i.e., a process in which the organic polymer and lignin are melt mixed. In the melt mixing process, the shear rate (which is related to the mixing speed in rpm) is typically at least or above 1 s⁻¹ and up to or less than 1000 s⁻¹. In some embodiments, the shear rate is about, for example, 1, 5, 10, 20, 30, 40, 50, 100, 150, 200, 250, 300, 350, 400, 500, 600, 700, 800, 900, or 1000 s⁻¹, or a shear rate within a range bounded by any two of the foregoing values. The mixing rate (in rpm) corresponding to the foregoing shear rate range is approximately 1-150 revolutions of the extruding screw (or blades) per minute. With respect to processing time (or residence time of material inside the mixer during continuous processing), the blending process typically employs a processing time (time during blending at a particular temperature and shear rate) of at least or above 1, 5, or 10 minutes and up to or less than 20, 30, or 45 minutes, such as a processing time of about, for example, 10, 15, 20, 25, 30, 35, 40, or 45 minutes, or a processing time within a range bounded by any two of the foregoing values. In some embodiments, such as in the case of a polyolefin (e.g., PP), the polymer may first be premixed at an elevated temperature at any of shear rates provided above before the lignin is added and the mixture blended for a period of time (processing time) at the elevated temperature. The elevated temperature is typically at or slightly above (e.g., 10-20% above) the softening point or melting point of the polymer, such as a temperature of about 160° C. to 200° C., or about 180° C., in the case of PP. The elevated temperature should also be at or above the softening point or melting point of the lignin.

In some embodiments, the blend of organic polymer and lignin is processed to produce a complex-shaped outer surface geometry fiber (e.g., multi-lobal fiber). By one method, the blend of organic polymer and lignin is processed as a non-fugitive component in combination with a fugitive (sacrificial) component using a multi-component fiber processing method (e.g., Hunt, Marcus A., et al. “Patterned functional carbon fibers from polyethylene.” Advanced Materials 24.18 (2012): 2386-2389) to produce a multi-component polymer fiber. The multi-component fiber is produced from, for example, a melt or solution of the respective components. The method includes subjecting a multi-component polymer fiber having a lignin-polymer mixed component as a non-fugitive polymer to a fugitive removal step to produce a complex-shaped outer surface geometry of lignin-blended polymer fiber. A complex-shaped outer surface geometry fiber (e.g., multi-lobal fiber) containing lignin-blended organic polymer is then treated with a solvent for lignin removal to produce a POP fiber with an ultrahigh surface area provided by the complex-shaped outer surface geometry.

In some embodiments, the POP fiber is made by solution processing using a solvent in which the organic polymer and lignin are both soluble. In this example, lignin and the organic polymer may be partially miscible. However, a medium or solvent is selected that specifically dissolves the lignin phase to produce the POP. As an example, dimethyl sulfoxide, dimethyl acetamide, or tetrahydrofuran solvent can be used to dissolve both polyacrylonitrile and lignin. The gel or solution can be spun in a mixture of water and a specific solvent, such as dimethyl sulfoxide, dimethyl acetamide, or tetrahydrofuran to produce a precipitated polyacrylonitrile-lignin blend fiber (e.g., Liu, H. C., Chien, A. T., Newcomb, B. A., Davijani, A. A. B., & Kumar, S. (2016). Stabilization kinetics of gel spun polyacrylonitrile/lignin blend fiber. Carbon, 101, 382-389). In some embodiments, the same solvent-swollen gel of polyacrylonitrile-lignin blend is used for electrospinning of fine electrospun mat (e.g., Ding, Rui, et al. “Processing and characterization of low-cost electrospun carbon fibers from organosolv lignin/polyacrylonitrile blends.” Carbon 100 (2016): 126-136). The resulting blend fiber or mat was partially crosslinked via cyclization and/or oxidation in air followed by washing out of the lignin phase in a solvent, such as dimethyl sulfoxide, dimethyl acetamide, or tetrahydrofuran or an aqueous alkali (e.g., aqueous solum hydroxide). Partial or full removal of lignin leaves a porous structure in the polyacrylonitrile fiber or the POP fiber.

The lignin can be any of the wide variety of lignin compositions found in nature in lignocellulosic biomass and as known in the art. As known in the art, the lignin compositions found in nature are generally not uniform. Lignin is a random copolymer that shows significant compositional variation between plant species. Many other conditions, such as environmental conditions, age, and method of processing, influence the lignin composition. Lignins are very rich aromatic compounds containing many hydroxyl (also possible carboxylic) functional groups attached differently to both aliphatic chains and phenolic rings. Additionally, some lignins possess highly branched structures. These characteristics of lignins determine their corresponding physical properties. The molar mass or molecular weight (M_{w}) of the lignin is generally broadly distributed, e.g., from approximately 1000 Dalton (D) to over 10,000 D. In typical embodiments, the lignin may have a number-average or weight-average molecular weight (i.e., Mₙ or M_{w}, respectively) of about, up to, or less than, for example, 300, 500, 1,000, 3,000, 5,000, 8,000, 10,000, 50,000, 100,000, 500,000 or 1,000,000 g/mol, or a weight within a range bounded by any two of the foregoing values, such as 500-10,000 g/mol or 500-5,000 g/mol [G. Fredheim, et al., J. Chromatogr. A, 2002, 942, 191; and A. Tolbert, et al., Biofuels, Bioproducts & Biorefining 8(6) 836-856 (2014)] wherein the term “about” generally indicates no more than ±10%, ±5%, or ±1% from an indicated value.

The lignin generally contains phenyl rings interconnected by the typical linking groups known to be in lignin, e.g., independently selected from one or more of ether (—O—) and alkylene linkages (e.g., —CH₂—, —CH₂CH₂—, —CH₂CH₂CH₂—, or —CH₂CH(CH₃)—) and wherein hydroxy and/or methoxy groups are attached to the phenyl rings. The alkylene linkages can be linear or branched, but typically, at least a portion of the alkylene linkages is branched. Typically, the phenyl rings are interconnected by linkages containing both ether and alkylene portions, e.g., —OCH(R)—, —OCH(R)CH(R)—, OCH(R)CH(R)CH(R)—, —OCH(CH₂OH)—, or —OCH(OH)CH(CH₂OH)—, where R can be, for example, H, OH, CH₂OH, or —O—. Thus, at least a portion of the linkages connecting phenyl rings is also typically substituted with hydroxy groups. The lignin structure typically includes ether (—O—) linkages and C—C covalent linkages. Some of these C—C covalent linkages can be alkylene linkages as mentioned earlier and wherein hydroxy and/or methoxy groups are attached to the phenyl rings.

In some embodiments, the lignin is significantly depolymerized when isolated from its native biomass source and has a molar mass of less than 1000 D. Their natural branches and low M_{w} generally result in very brittle characteristics. The aromatic structures and rich functional groups of lignins also lead to varied rigid and thermal properties. Lignins are amorphous polymers, which results in very broad glass transition temperatures (T_{g}), from ca. 80° C. to over 200° C. The glass transition temperatures are critical temperatures at which the lignin macromolecular segments become mobile. Some lignins exhibit a very good flow property (low molten viscosity), whereas others display several orders of magnitude higher viscosity.

Lignins differ mainly in the ratio of three alcohol monomer units, i.e., p-coumaryl alcohol, guaiacyl alcohol, and sinapyl alcohol. The polymerization of p-coumaryl alcohol, coniferyl alcohol, and sinapyl alcohol forms the p-hydroxyphenyl (H), guaiacyl (G), and syringyl (S) components of the lignin polymer, respectively. The lignin can have any of a wide variety of relative weight percents (wt %) of H, G, and S components or their derivatives. As observed in some seeds, lignin may also consist of caffeyl alcohol units, e.g., Chen et al., Proc. Natl. Acad. Sci. U.S.A, 109(5), 1772-1777 (2012). For example, the precursor lignin may contain, independently for each component, at least, up to, or less than 1 wt %, 2 wt %, 5 wt %, 10 wt %, 20 wt %, 30 wt %, 40 wt %, 50 wt %, 60 wt %, 70 wt %, 80 wt %, or 90 wt %, or within a range thereof, of any of the caffeyl alcohol, H, G, and S components. Typically, the sum of the wt % of each alcohol component is 100%, or at least 98% if other minor components are considered. Different wood and plant sources (e.g., hardwood (HW), such as oak, maple, poplar, and the like; softwood (SW), such as pine, spruce, and the like; or grass or perennial plant-derived lignins, such as switch grass, corn, bamboo, perennial grass, orchard grass, alfalfa, wheat, miscanthus, bamboo, and bagasse) often widely differ in their lignin compositions, and are all considered herein as sources of lignin. In some embodiments, depending on the desired characteristics of the emulsion or hierarchical assembly, any one or more types of lignin, as described above, may be excluded from the composition.

Besides the natural variation of lignins, there can be further compositional variation based on the manner in which the source lignin has been processed. For example, the source lignin can be a Kraft lignin, sulfite lignin (i.e., lignosulfonate), or a sulfur-free lignin. As known in the art, a Kraft lignin refers to lignin that results from the Kraft process. In the Kraft process, a combination of sodium hydroxide and sodium sulfide (known as “white liquor”) is reacted with lignin present in biomass to form a dark-colored lignin bearing thiol groups. Kraft lignins are generally water- and solvent-insoluble materials with a high concentration of phenolic groups. They can typically be made soluble in aqueous alkaline solution. As also known in the art, sulfite lignin refers to lignin that results from the sulfite process. In the sulfite process, sulfite or bisulfite (depending on pH), along with a counterion, is reacted with lignin to form a lignin bearing sulfonate (SO₃H) groups. The sulfonate groups impart a substantial degree of water-solubility to the sulfite lignin.

There are several types of sulfur-free lignins known in the art, including lignin obtained from biomass conversion technologies (such as those used in ethanol production), solvent pulping (i.e., the “organosolv” process), soda pulping (i.e., “soda lignin”), and supercritical water fractionation or oxidation (i.e., “supercritical water fractionated lignin”). In particular, organosolv lignins are obtained by solvent extraction from a lignocellulosic source, such as chipped wood, followed by precipitation. The solvent system in organosolv delignification of biomass often include organic alcohols, such as methanol, ethanol, propanol, butanol, and isobutyl alcohol; aromatic alcohols, such as phenol and benzyl alcohol; glycols, such as ethylene glycol, triethylene glycol, propylene glycol, butylene glycol, and other higher glycols; ketones, such as acetone, methyl ethyl ketone, and methyl isobutyl ketone; organic acids, such as formic acid, acetic acid and propionic acid, amines, aldehydes, esters, organic nitrile compounds, diethyl ether, dioxane, glycerol, and mixtures of these solvents. Typically, some degree of dilute acid pretreatment of biomass helps the delignification process. Due to the significantly milder conditions employed in producing organosolv lignins (i.e., in contrast to Kraft and sulfite processes), organosolv lignins are generally purer, less degraded, and generally possess a narrower molecular weight distribution than Kraft and sulfite lignins. These lignins can also be thermally devolatilized to produce a variant with less aliphatic hydroxyl groups, and molecularly restructured forms with an elevated softening point. Any one or more of the foregoing types of lignins may be used (or excluded) as a component in the compositions and methods described herein.

The lignin may also be an engineered form of lignin having a specific or optimized ratio of H, G, and S components. Lignin can be engineered by, for example, transgenic and recombinant DNA methods known in the art that cause a variation in the chemical structure of lignin and overall lignin content in biomass (e.g., F. Chen, et al., Nature Biotechnology, 25(7), pp. 759-761 (2007) and A. M. Anterola, et al., Phytochemistry, 61, pp. 221-294 (2002)). The engineering of lignin is particularly directed to altering the ratio of G and S components of lignin (D. Guo, et al., The Plant Cell, 13, pp. 73-88, (January 2001). In particular, wood pulping kinetic studies show that an increase in S/G ratio significantly enhances the rate of lignin removal (L. Li, et al., Proceedings of The National Academy of Sciences of The United States of America, 100 (8), pp. 4939-4944 (2003)). The S units become covalently connected with two lignol monomers; on the other hand, G units can connect to three other units. Thus, an increased G content (decreasing S/G ratio) generally produces a highly branched lignin structure with more C—C bonding. In contrast, increased S content generally results in more β-aryl ether (β-O-4) linkages, which easily cleave (as compared to C—C bond) during chemical delignification, e.g., as in the Kraft pulping process. It has been shown that decreasing lignin content and altering the S/G ratio improve bioconvertibility and delignification. Thus, less harsh and damaging conditions can be used for delignification (i.e., as compared to current practice using strong acid or base), which would provide a more improved lignin better suited for higher value applications.

Lab-scale biomass fermentations that leave a high lignin content residue have been investigated (S. D. Brown, et al., Applied Biochemistry and Biotechnology, 137, pp. 663-674 (2007)). These residues will contain lignin with varied molecular structures depending on the biomass source (e.g., wood species, grass, and straw). Production of value-added products from these high quality lignins would greatly improve the overall operating costs of a biorefinery. Various chemical routes have been proposed to obtain value-added products from lignin (J. E. Holladay, et al., Top Value-Added Chemicals from Biomass: Volume II—Results of Screening for Potential Candidates from Biorefinery Lignin, DOE Report, PNNL-16983 (October 2007)).

The lignin may, in some embodiments, be a crosslinked lignin that is melt-processible or amenable to melt-processing. The term “crosslinked” can mean, for example, that the lignin contains methylene (i.e., —CH₂—) and/or ethylene (i.e., —CH₂CH₂—) linkages (i.e., linking groups) between phenyl ring carbon atoms in the lignin structure. In some embodiments, a mild polycondensation condition can be used, such as by formaldehyde crosslinking of phenols or self-condensation by reaction between carboxylic acid and aliphatic hydroxy groups in the presence of appropriate catalysts to yield branched segments from these functionally enriched oligomers. In some embodiments, lignin is crosslinked by reacting it with dicarboxylic acid small molecules, such as succinic acid or tri- or tetra-carboxylic acid containing small molecules, via an esterification reaction. By being “melt-processible” is meant that the crosslinked lignin can be softened, sheared, and melted or converted to a molten, highly viscous, or rubbery state starting at a particular glass transition temperature. The melted or highly viscous lignin can then be more easily processed, such as by mixing, molding, applying on a surface, or dissolving in a solvent. In some embodiments, the lignin is not crosslinked.

In some embodiments, the lignin exhibits a suitable steady shear viscosity to render it as a malleable film-forming material at the processing temperature and shear rate employed. Typically, at a low-shear melt processing condition (e.g., at 1-100 s⁻¹ shear rate regime), the steady shear viscosity of the lignin component is at least or above 100 Pa·s, 500 Pa·s, 1000 Pa·s, 3000 Pa·s, or 5000 Pa·s, or within a range therein. In some embodiments, the lignin forms a highly viscous melt (on the order of 10,000 Pa·s complex viscosity or higher) at a 100 s⁻¹ shear rate. In some embodiments, the lignin may be oxidized (e.g., by exposure to a chemical oxidizing agent), while in other embodiments, the lignin is not oxidized. In some embodiments, the lignin is chemically unmodified in the dispersion relative to its natural extracted or isolated form. In some embodiments, the lignin is chemically modified by acetylation, oxypropylation, hydroxymethylation, epoxidation, or the like, as known in the art. In some embodiments, the lignin is plasticized with solvents or plasticizers to induce melt-processability. Solvents and plasticizers include, for example, dimethylsulfoxide, dimethylacetamide, polyoxyalkylene, ethylene carbonate, propylene carbonate, and glycerol, as known in the art. In some embodiments, the use of a solvent or plasticizer is excluded.

In different embodiments, the lignin (either isolated or extracted lignin from biomass or its crosslinked derivative) has a glass transition temperature of precisely or about, for example, 40° C., 50° C., 60° C., 70° C., 80° C., 90° C., 100° C., 105° C., 110° C., 115° C., 120° C., 125° C., 130° C., 140° C., 150° C., 160° C., 170° C., 180° C., 190° C., 200° C., 210° C., 220° C., 230° C., or 240° C., or a T_{g} within a range bounded by any two of the foregoing values. In some embodiments, the lignin does not exhibit a detectable T_{g}, unless mixed with a plasticizing component such as solvent, or polymeric additives. In some embodiments, lignin undergoes a degradation reaction before exhibiting a discernible T_{g}.

The lignin (in either raw form isolated from biomass or a crosslinked derivative) may be substantially soluble in a polar organic solvent or aqueous alkaline solution. As used herein, the term “substantially soluble” generally indicates that at least 1, 2, 5, 10, 20, 30, 40, 50, or 60 grams of the lignin completely dissolves in 1 deciliter (100 mL) of the polar organic solvent or aqueous alkaline solution. In other embodiments, the solubility is expressed as a wt % of the lignin in solution. In some embodiments, the lignin has sufficient solubility to produce at least a 5 wt %, 10 wt %, 15 wt %, 20 wt %, 30 wt %, 40 wt %, or 50 wt % solution in the polar organic solvent or aqueous alkaline solution. The polar organic solvent can be aprotic or protic. Some examples of polar aprotic solvents include the organoethers (e.g., diethyl ether, tetrahydrofuran, and dioxane), nitriles (e.g., acetonitrile, propionitrile), sulfoxides (e.g., dimethylsulfoxide), amides (e.g., dimethylformamide, N,N-dimethylacetamide), organochlorides (e.g., methylene chloride, chloroform, 1,1-trichloroethane), ketones (e.g., acetone, 2-butanone), and dialkylcarbonates (e.g., ethylene carbonate, dimethylcarbonate, diethylcarbonate). Some examples of polar organic protic solvents include alcohols (e.g., methanol, ethanol, isopropanol, n-butanol, t-butanol, pentanols, hexanols, octanols, or the like), diols (e.g., ethylene glycol, diethylene glycol, triethylene glycol), and protic amines (e.g., ethylenediamine, ethanolamine, diethanolamine, and triethanolamine). The aqueous alkaline solution can be any aqueous-containing solution having a pH of at least (or over) 8, 9, 10, 11, 12, or 13. The alkalizing solute can be, for example, an alkali hydroxide (e.g., NaOH or KOH), ammonia, or ammonium hydroxide. Combinations of any of these solvents may also be used.

In some embodiments, the lignin is dissolved in a solvent when used to form the blend of organic polymer and lignin. The solvent may or may not be incorporated into the blend. Any of the above solvents may also be used for removing the lignin from the fibers made of the polymer-lignin blend. In some embodiments, one or more classes or specific types of solvents (or all solvents) are excluded from the blend from which the precursor fiber is produced.

In another aspect, the present disclosure is directed to a method for removing oil from an oil-water mixture by use of the above described POP fibers. In the method, the oil-water mixture is contacted with the POP fibers. On contact, the oil selectively absorbs (i.e., by selective capillary action) into pores of the POP fibers. In embodiments of the method, a woven or non-woven material constructed of the POP fibers is contacted with the oil-water mixture. In embodiments, the water is a natural body of water (e.g., an ocean, lake, or pond) and the oil resulted from an oil spill. Notably, although oil is a typical contaminant requiring removal, the POP fibers described herein may selectively remove other similarly hydrophobic substances from water, such as polycyclic aromatic hydrocarbons (PAHs) and polychlorinated biphenyls (PCBs). The POP fibers can absorb many times their own weight in oil, such as at least, for example, 200 wt %, 300 wt %, 400 wt %, 500 wt %, 600 wt %, 700 wt %, 800 wt %, 900 wt %, or 1000 wt % of the fiber weight.

In some embodiments, the oil-absorbed or solvent-absorbed (i.e., oil-soaked or solvent-soaked) POP fiber is then continuously passed through a vertical column of water from top to bottom where oil or hydrophobic liquid/chemicals are separated from the fiber and float in the column of water to perform physical gravitational separation of oil or solvent separation from the fiber and subsequent re-use of the POP fibers. In some embodiments, oil-absorbed or solvent-absorbed POP fibers are disposed or burnt for combined fuel value without requiring recovery and re-use of the POP fibers.

The POP fibers also have the properties of high mechanical strength and thermal conductivity. Thus, the POP fibers may also be used in applications requiring or benefitting from such properties. The POP fibers are light weight and have desirable thermal-mechanical properties, which make them suitable for use in aerospace and automotive applications. The POP fibers are also electrically insulating and thermally conductive, which makes them suitable for use in electronics, including as heat sinks and electronic packaging. The POP fibers may also be used as large-scale radiative cooling fabrics. The POP fibers are also biocompatible, which makes them suitable for use in biological applications. The POP fibers, particularly those based on PAN or copolymer thereof, may be used for gas absorption and separation, e.g., absorption and separation of carbon dioxide from the air or an industrial emission or exhaust.

Examples have been set forth below for the purpose of illustration and to describe certain specific embodiments of the invention. However, the scope of this invention is not to be in any way limited by the examples set forth herein.

### Example 1

Overview

The following experiments rely on temperature-induced miscibility between oligomeric lignin and PP followed by stress-induced crystallization of polymer matrix during high-speed fiber spinning to create approximately 100 times smaller lignin phase segregation than those obtained by a regular molding method. Lignin was used as a sacrificial material to generate a porous PP structure. Lignin micro-domains were subsequently removed from the PP fiber matrix by its solubilization in a solvent, such as dimethylformamide, during continuous washing of the filaments. The porous PP fibers can be used in various applications, such as oil spill removal, membranes, flexible supercapacitors, liquid repellency, and phase change materials for heat storage. The following experiments employed PP and recycled PP in combination with lignin to prepare hierarchically porous PP fibers for separation of oil from water.

Methods

Porous PP fibers were generated by using lignin as a sacrificial component in a PP-lignin blend containing 40 wt. % lignin (60 wt. % PP). PP or recycled PP was melt-blended with Organosolv hardwood lignin. Lignin phase separation within PP matrix was tuned during a melt-spinning process. PP-lignin fibers showed the presence of lignin nano-cylinders in the PP. These nano-lignin domains were removed by using solvents to generate nanoporous PP fibers. Some lignin-PP blend compositions contained 20 wt % to 60 wt % lignin and could be melt-spun in fiber form. The rheological properties of these compositions permit them to be melt-blown to produce melt-blown non-woven mats with small filament diameters.

Materials. Isotactic polypropylene (PP) with a melt flow index of 4 g/10 min was obtained from a commercial source. Organosolv hardwood lignin (Alcell), dimethylformamide, and acetone were also obtained from commercial sources. All materials were used without purification.

Material blending. PP was premixed at 180° C. with a speed of 90 rpm for 2 minutes in a Brabender Plasti-Corder Torque Rheometer equipped with a half-size mixing chamber. The lignin was then added and further mixed for a total of 15 minutes. In this study, the blended sample was prepared using 60 wt. % PP and 40 wt. % lignin. The sample was collected, cut into small pieces, and stored at ambient temperature for other characterizations. The recycled PP in the lignin blend was prepared in the same manner.

Molding samples and melt-spinning fibers. The blended sample was pressed at 190° C. under a pressure of 4 metric tons for 10 minutes by a hydraulic Carver press. The PP-lignin fibers were prepared by melt-spinning at 200° C. using a 150-micron meter diameter die using a customized one-shot extruder.

Scanning electron microscopy (SEM) measurements. Cross-sections of molded samples and melt-spun fibers were collected using a field emission microscope. All measurements were conducted with a 10 KV accelerating voltage and a working distance of 9-10 mm.

Two-dimensional wide-angle X-ray scattering (2D-WAXS) measurements. 2D-WAXS data of molded and melt-spun samples were collected using an SAXS measuring system equipped with an imaging multi-sensitive storage phosphor plate. The recorded imaging data were read by an imaging plate reader. The X-ray beam used Cu—Kα with λ=1.541 Å generated at 40 Kv/50 mA. The collected data were analyzed using commercial software. Integrated data in three selected directions, 0°, 45°, and 90°, were employed to fit and compute the Herman's orientation factor (f) (ref).

Rheology measurements. Rheological properties of the PP-lignin sample were characterized using a commercial rheological tester capable of precise temperature control, strain sweeping, and frequency sweeping. All melt rheology studies were conducted at selected temperatures, including 170° C., 190° C., 210° C., and 230° C., using 8 mm diameter parallel plates. Different strain sweeps at 100 rad/s were conducted to determine the linear elastic response of the material. Frequency sweeps from 100 to 0.1 rad/s at the studied temperatures were performed.

Thermal Analysis. Thermal properties of selected samples were collected at different ramp rates using a differential scanning calorimeter. The sample mass was from 3-4 mg. Three different heating (from −80 to 230° C.) and cooling (from 230 to −80° C.) cycles were performed.

Lignin removal process and oil/water uptake measurements. Melt-spun lignin fibers were washed in DMF by stirring them at 200 rpm at 50° C. for 24 hours, then washed with acetone for 30 mins at ambient temperature. The washed sample was dried in an oven at 40° C. overnight. The mass of the sample before and after washing was measured to calculate the efficiency of lignin removal. To measure the oil or water uptake, the porous PP fibers were soaked in the vials containing used pump oil floating on water for 30 seconds. The total mass of fibers was weighed and compared with the original mass of the porous fibers before soaking. The water uptake was measured similarly. The estimated oil uptake was calculated by subtracting the water uptake amount. An average of three different measurements was used to report.

Results and Discussion

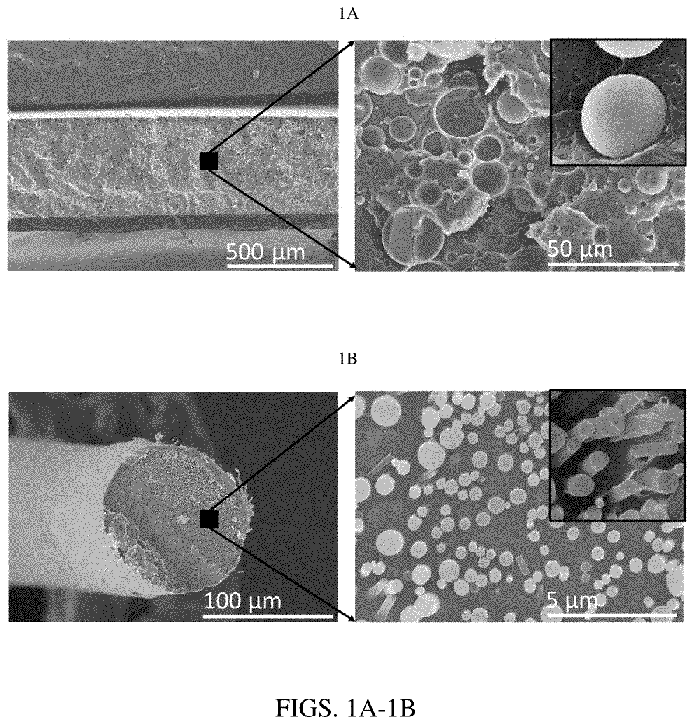

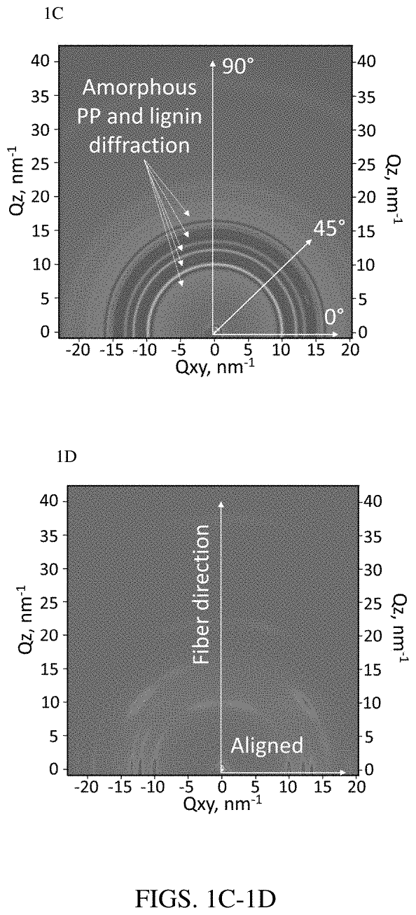

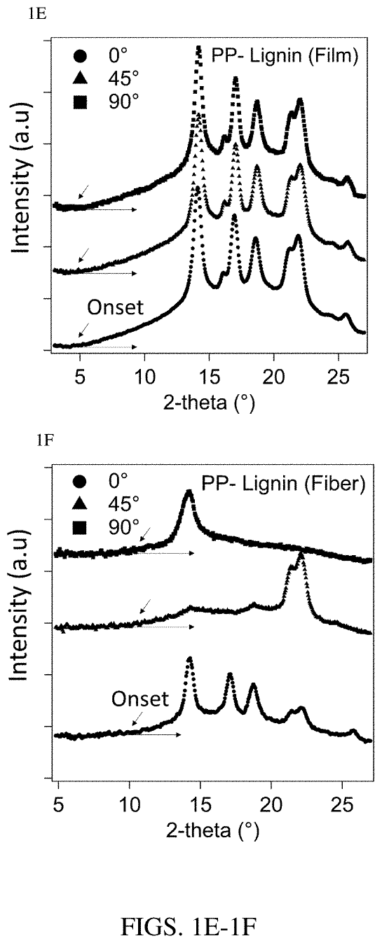

The experiments initially demonstrated control of nanoscale lignin phase separation within a PP matrix by use of axial stress during a melt-spinning process or simply spin-line stress. During the fiber melt-spinning operation, a jet of melt from a fine orifice was pulled (or stretched) along the length to obtain a smaller diameter filament. While the temperature of the melt gradually decreases from the orifice surface along the spin-line, the axial stress gradually increases until the filament reaches a solidification temperature. The PP matrix also experiences crystallization along the spin-line, and the stretch-induced crystallization assists the nanoscale phase separation of lignin. While compression molded PP-lignin film (60-40 wt % mix) resulted in 10-25 μm lignin spherical particles in the PP matrix (FIG. 1A), melt-spun PP-lignin fiber exhibited nanoscale 200-650 nm lignin domains within the PP matrix (FIG. 1B). The phase separation of lignin is consistent with the van Gurp-Palmen plot presenting phase angle as a function of absolute complex modulus (G*). The phase angle collected at different temperatures indicates some deviation within 103-105 Pa due to different relaxation times of separated domains or aggregated phases. However, the addition of lignin within the PP matrix results in better processing characteristics. The PP-lignin has a faster relaxation time and low melt flow viscosity in comparison to neat PP, as demonstrated by the measured relaxation spectra and the shear rate-dependent viscosity collected at 230° C. This is because lignin has a much lower melt-stiffness than neat PP. The experiments demonstrate that melt-spinning the PP-lignin material permits a controlled morphology and better lignin dispersion with much smaller phase-separated domains.

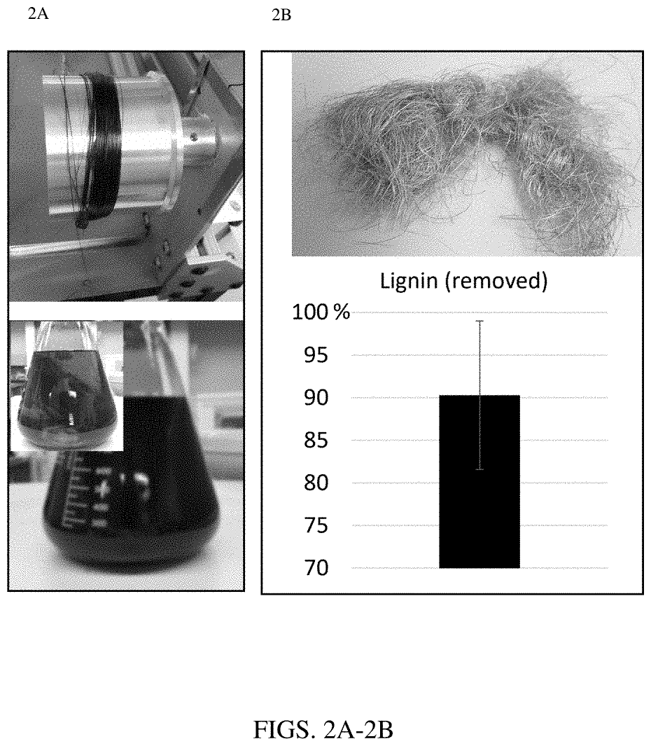

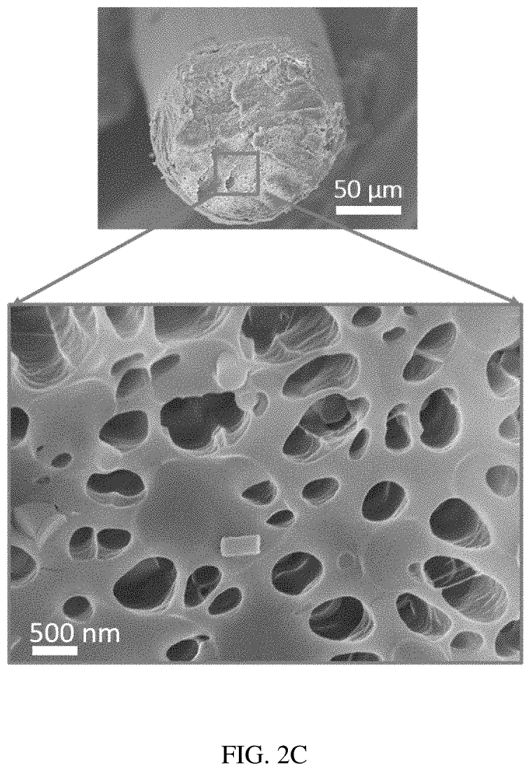

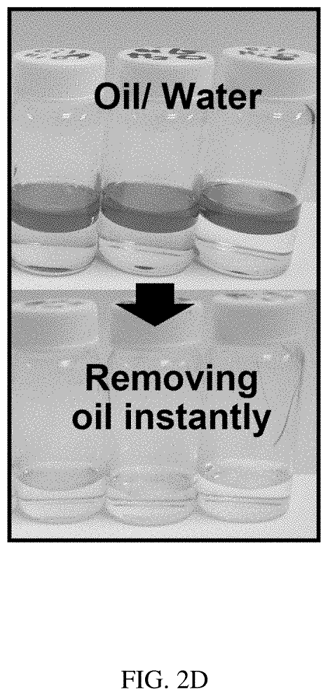

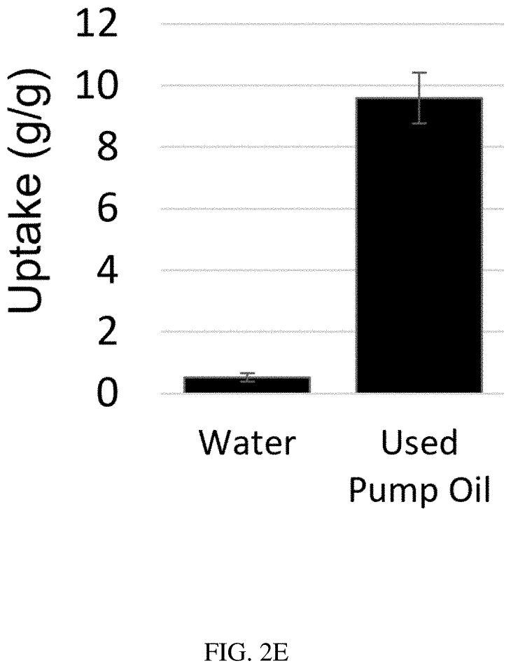

Alignment of PP polymeric chains during melt-spinning has been well investigated. The following experiments use the external stress exerted during the fiber spinning process and PP crystallization to induce lignin phase separation, deformation, and alignment along PP fiber axis. The enlarged SEM image and inset image in FIG. 1B (right) display lignin cylinders formed in the spun fiber. The hardwood lignin used in this study has a low glass transition temperature (86.2±1.2° C.). The presence of lignin also promotes nucleation of PP crystallites from the melt at higher temperatures. The data in FIGS. 2C-2F reveal PP alignment along the fiber direction. FIG. 1C shows the amorphous halo from PP-lignin film diffraction. The diffraction halo, however, disappears in the spun fiber (FIG. 2D) with reflection of orientated phases.

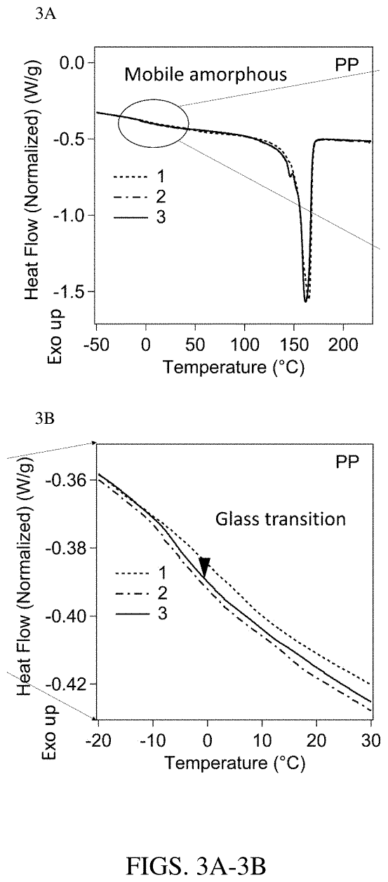

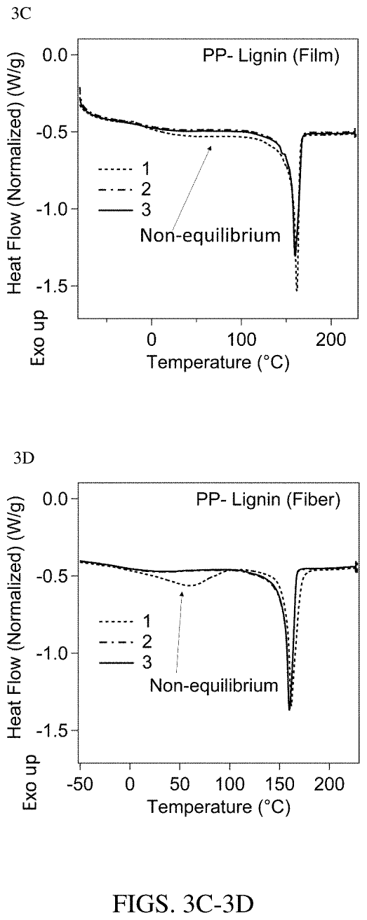

Shown in FIGS. 1E and 1F are the line scan intensity at different angles as a function of 2-theta of a molded and spun sample, respectively. The data indicate the onset of amorphous diffraction contribution in the molded PP-lignin sample shifting from ca. 5° to ca. 10° for the fibers (as marked by the arrows). This is further confirmed by the measured DSC data. Heat flow curves of the studied samples demonstrate that lignin has a significant impact on the PP mobile amorphous transition temperature. FIGS. 3A-3D are graphs showing heat flow as a function of temperature in three heating cycles of: pristine PP (FIG. 3A); zoomed-in glass transition temperature of PP contributed by mobile amorphous segments (FIG. 3B); PP-lignin film (FIG. 3C); and PP-lignin fiber (FIG. 3D). FIGS. 3A and 3B show the glass transition temperature (T_{g}) of PP. The dotted curve is the first heating cycle. The second and third heating cycles are identical. The PP-lignin molded sample (film) and PP-lignin fiber exhibit a significant deviation starting at the T_{g} of PP, due to the interference of lignin macromolecules with the PP mobile amorphous chains. A significant effect of lignin is observed from the first heating cycle DSC thermogram of PP-lignin fiber formed by a non-equilibrium state induced by the melt-spinning process.

Lignin has a glass transition temperature of 80-90° C. (N. A. Nguyen, C. C. Bowland and A. K. Naskar, Applied Materials Today, 2018, 12, 138-152), while the mobile amorphous PP indicates a glass transition temperature at ca. 0° C. (FIGS. 3A and 3B). There is a thermal transition temperature of these PP-lignin samples at around 50° C., as shown in FIGS. 3C and 3D. The signal associated with the non-equilibrium state in the first heating cycle was pronounced in the PP-lignin fiber sample, as shown in FIG. 3D. The DSC data revealed that the second and third heating cycles were identical and rapid heating and cooling cycles erase the presence of the non-equilibrium state rigid amorphous structure that likely requires a longer time to build. Most likely, the external stresses coming from compression molding and the fiber melt-spinning processes result in building the non-equilibrium state with confinement of amorphous PP chains and intercalation of lignin and PP molecules in the rigid amorphous fraction. Therefore, by using contrasting thermal behaviors of amorphous lignin and amorphous and crystalline PP under the influence of external stress applied in a non-equilibrium process such as fiber spinning, it was possible to generate well-dispersed nano-domains of lignin within PP fibers.

The simple method developed in this study to control nanoscale phase separation of lignin within the PP matrix can be utilized to generate nanoporous PP fibers for a wide range of applications including membrane, large-scale radiative cooling fabrics, and oil spill absorbent materials. In this study, porous PP fibers were generated using lignin as a sacrificial pore-generating template in the PP-lignin blend containing 40 wt. % lignin. _PP or recycled PP was melt-blended with Organosolv hardwood lignin. _Lignin phase separation within the PP matrix was tuned during a melt-spinning process. PP-lignin fibers contain lignin nano-cylinders in the PP. These lignin nano-domains were washed using solvents to generate nanoporous PP fibers (FIG. 2A). The simple method presented in this disclosure to control nano-scale phase separation of lignin within the PP matrix can be utilized to generate nanoporous PP fibers for a wide range of applications, not limited to membrane, large-scale radiative cooling fabrics, and oil spill absorbent materials. The digital image in FIG. 2B is the spun PP fiber after removing lignin. The efficacy of lignin removal is 92±7%. The porous PP fiber with nanopore structure is shown in FIG. 2C.

Notably, the facile method described herein using controllable phase separation of lignin to generate porous structures opens a new door to tune the PP porosity. By selecting appropriate lignin structures through thermal processing, solvent fractionation, and/or varying lignin sources, tunable lignin-PP interactions can be employed to create desirable morphologies of lignin within the PP matrix. Additionally, a combination of applied stress during PP crystallization or cold stretching of the fiber can be further tailored and retained to generate secondary nanoporous structures.

An example of using nanoporous PP fibers for oil removal is illustrated in FIG. 2D. The images show used pump oil floating on water (top) and water only after removal of oil using the porous PP fibers (bottom). The oil was removed instantly after dropping the nanoporous PP fibers into the oil/water mixtures. The data shown in FIG. 2E are oil and water uptakes measured in this study. The oil uptake was found to be 9.59±0.82 (g/g), whereas PP (being hydrophobic) can uptake only a very small amount of water, 0.51±0.14 (g/g).

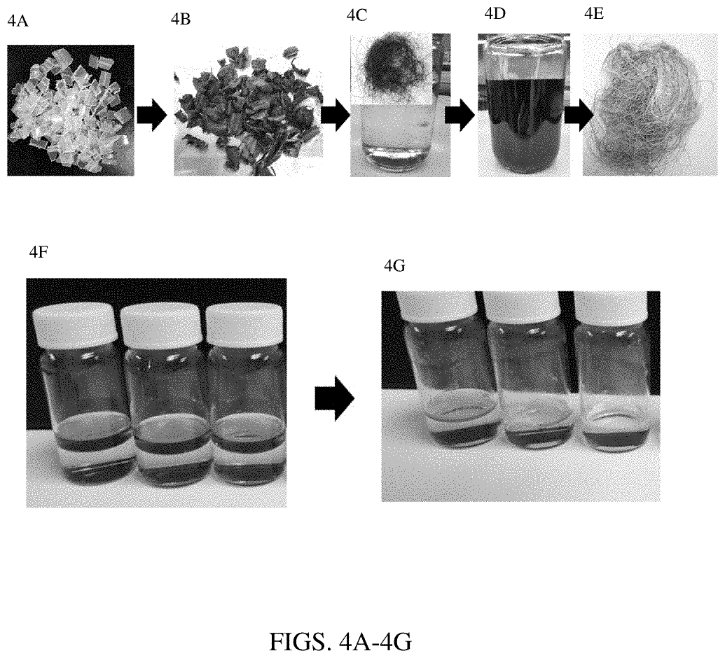

Finally, an example of using recycled PP and lignin to make porous PP fibers for oil removal is schematically illustrated in FIGS. 4A-4G. FIG. 4A shows recycled PP. FIG. 4B shows a blend of recycled PP with 40 wt. % lignin. FIG. 4C shows melt-spun recycled PP-lignin fibers. FIG. 4D shows the removal of lignin from melt-spun recycled PP-lignin fibers. FIG. 4E shows porous PP fibers after removing lignin. FIG. 4F shows an oil/water mixture with oil floating at the top. FIG. 4G shows oil removed from the oil-water mixture after contact with the recycled porous PP fibers. The use of recycled PP and lignin to make porous PP fibers for oil removal was also demonstrated.

In summary, the present experiments demonstrate the upcycling of lignin, a byproduct from the biorefinery industry, to generate controllable nanoscale phase-separated domains within a PP matrix. As described above, the lignin domains were used as a sacrificial material to create primary porous structures of the PP matrix, and this has been combined with traditional fiber forming methods including cold stretching of PP fibers to create secondary porosity in the fibers. Utilization of recycled PP and a renewable material (lignin) add new values for the waste stream and will create a new avenue to solve environmental challenges such as oil-spill from offshore drilling units.

### Example 2

Plasticized Polyethylene Terephthalate (PET) and Blend with Lignin

Lignin usually degrades at temperatures above 230° C. Thus, it is difficult to blend with any polymer that melts above 230° C. PET melts above 260° C. However, fatty acid plasticized PET generally melts below lignin degradation temperature (e.g., Naskar et al., U.S. Pat. No. 11,279,805). Plasticized PET containing 20 wt % to 50 wt % lignin could be melt-spun at high speed to obtain a fiber tow. These filaments, when treated with tetrahydrofuran or aqueous alkali (aq. NaOH solution) to dissolve the lignin phase, result in microporous PET fibers. These fibers made of plasticized PET containing 10 wt % to 50 wt % lignin may be spun into trilobal, octa-lobal filaments, or corona-shaped high-surface area fibers by using polylactic acid (PLA) as fugitive phase. Plasticized PET containing 10 wt % to 50 wt % lignin and PLA may be spun through a bi-component melt-spinning device at 220° C. Both PLA and lignin could be dissolved in aq. alkali to obtain high surface area multi-lobal porous PET fiber (POP fiber) useful for the removal of oil or other hydrophobic substance. Some lignin-PET blend compositions containing 10 wt % to 50 wt % lignin may be melt-blown to produce melt-blown non-woven mats with small filament diameters. These non-woven products may undergo a lignin removal process to produce highly porous non-woven fibers useful for removing grease and oil.

### Example 3

Nylon 12 Blends with Lignin

Low-melting nylon 12 melts below the lignin degradation temperature, and thus, nylon polymers containing 20 wt % to 60 wt % lignin may be melt-spun at high speed to obtain multi-filament tows following methods provided in, e.g., Nguyen et al. (Science Advances 2018; 4: eaat4967). The melt may be extruded and melt-spun at temperatures ranging from 190° C. to 230° C. These filaments, when treated with tetrahydrofuran or aqueous alkali (aq. NaOH solution) to dissolve the lignin phase, result in microporous nylon 12 fibers. These fibers made of nylon 12 containing 10 wt % to 60 wt % lignin (i.e., lignin-filled organic polymeric fibers) may be spun into trilobal, octa-lobal filaments, or corona-shaped high-surface area fibers by using polylactic acid (PLA) as a fugitive phase. A nylon 12 matrix containing 10 wt % to 60 wt % lignin as a non-fugitive component and PLA as a fugitive component may be spun through a bi-component melt-spinning device at 220 C. Both PLA and lignin may be dissolved in aq. alkali to obtain high surface area multi-lobal porous nylon 12 fiber (POP fiber) useful for the removal of oil or other hydrophobic substance and subsequent recovery of POP fibers and re-use. The lignin-modified nylon 12 matrix may be melt-blown to produce melt-blown non-woven mats with small filament diameters (200 nm-5 micrometer). These non-woven products may undergo a roll-to-roll processing method for lignin removal to create highly porous non-woven fibers useful for removing grease and oil.

### Example 4

PAN Blends with Lignin and Solution Spun Fibers

In this example, polymer polyacrylonitrile (PAN) and lignin are mixed in a solvated state in a common solvent (e.g., dimethyl sulfoxide or dimethyl acetamide) followed by solution-spinning or electrospinning to form the organic polymer-lignin blend fiber prior to separation or removal of lignin via solvent dissolution to produce the POP fiber. A standard PAN fiber spinning method was followed (e.g., Morris et al. Carbon 101, 245-252 (2016)). Lignin may be removed from the polyacrylonitrile matrix by treating the fiber or electrospun mat in aqueous alkali to obtain POP products. The solvated gel may contain 10-70% lignin for subsequent lignin removal to obtain ultra-high porosity POP products. The shape of the POP fiber may also be tailored by multi-component solution spinning to produce multi-lobal high surface area organic polymer fiber prior to lignin removal using a standard spinneret head assembly (e.g., Hunt et al. Advanced Materials 24.18 (2012): 2386-2389).

While there have been shown and described what are at present considered the preferred embodiments of the invention, those skilled in the art may make various changes and modifications which remain within the scope of the invention defined by the appended claims.

What is claimed is:

1. A porous composition comprising a porous organic polymer fiber having a diameter of at least 100 nm and a length of at least 1 mm and pores having a size within a range of 10 nm to 5 microns distributed over the surface and volume of the porous organic polymer fiber, wherein the organic polymer is insoluble in water.

2. The porous composition of claim 1, wherein the porous organic polymer fiber has a diameter of at least 1 micron.

3. The porous composition of claim 1, wherein the porous organic polymer fiber has a diameter of at least 10 microns.

4. The porous composition of claim 1, wherein at least 80% of said pores have a size in a range of 50 nm to 2 microns distributed over the surface of the porous organic polymer fiber.

5. The porous composition of claim 1, wherein at least 80% of said pores have a size in a range of 100 nm to 1 micron distributed over the surface of the porous organic polymer fiber.

6. The porous composition of claim 1, wherein the organic polymer comprises a polyolefin.

7. The porous composition of claim 6, wherein the polyolefin comprises polypropylene.

8. The porous composition of claim 6, wherein the polyolefin comprises polyethylene.

9. The porous composition of claim 1, wherein the organic polymer comprises a polyester.

10. The porous composition of claim 9, wherein the polyester comprises polyethylene terephthalate.

11. The porous composition of claim 1, wherein the organic polymer comprises a polyamide.

12. The porous composition of claim 1, wherein the organic polymer comprises polyacrylonitrile.

13. The porous composition of claim 1, wherein the porous composition comprises a woven or non-woven material constructed of said porous organic polymer fiber.

14. A method for producing a porous organic polymer fiber, the method comprising:
(i) forming a precursor fiber from a blend of an organic polymer and lignin, wherein the organic polymer and lignin are immiscible with each other and the organic polymer is insoluble in water; the precursor fiber has a diameter of at least 100 nm and a length of at least 1 mm; and the lignin is present in the form of domains within said organic polymer in said blend and resulting precursor fiber, wherein the domains have a size within a range of 10 nm to 5 microns; and
(ii) washing said precursor fiber with a solvent that dissolves the lignin to result in the porous organic polymer fiber, wherein the porous organic polymer fiber has a diameter of at least 100 nm and a length of at least 1 mm and pores having a size within a range of 10 nm to 5 microns distributed over the surface and volume of the porous organic polymer fiber.

15. The method of claim 14, wherein the organic polymer comprises a polyolefin.

16. The method of claim 15, wherein the polyolefin comprises polypropylene.

17. The method of claim 15, wherein the polyolefin comprises polyethylene.

18. The method of claim 14, wherein the organic polymer comprises a polyester.

19. The method of claim 18, wherein the polyester comprises polyethylene terephthalate.

20. The method of claim 14, wherein the organic polymer comprises a polyamide.

21. The method of claim 14, wherein the organic polymer comprises polyacrylonitrile.

22. The method of claim 14, wherein the precursor fiber is formed in step (i) by melt spinning the blend of the organic polymer and lignin.

23. The method of claim 14, wherein the blend of the organic polymer and lignin is produced, before step (i), by a process in which the organic polymer and lignin are melt blended.

24. A method for removing oil from an oil-water mixture, the method comprising contacting the oil-water mixture with a porous composition comprising porous organic polymer fibers having a diameter of at least 100 nm and a length of at least 1 mm and pores having a size within a range of 10 nm to 5 microns distributed over the surface and volume of the porous organic polymer fiber, wherein the organic polymer is insoluble in water.

25. The method of claim 24, wherein the porous composition comprises a woven or non-woven material constructed of said porous organic polymer fiber.
